(19) United States
(12) Patent Application Publication
(10) Pub. No.: US 2006/0046542 A1
(43) Pub. Date: Mar. 2, 2006

(54) Card connector device

(75) Inventors: Shu Obara, Tokyo (JP); Koichi Kagotani, Tokyo (JP)

Correspondence Address: TAKEUCHI & KUBOTERA, LLP, Suite 202, 200 Daingerfield Road, Alexandria, VA, 22314, US

(73) Assignee: Hirose Electric Co., Ltd.

(21) Appl. No.: 11/201,103

(22) Filed: Aug. 11, 2005

(30) Foreign Application Priority Data
Aug. 30, 2004 (JP) 2004-249626

(51) Int. Cl. H01R 13/44

(52) U.S. Cl. 439/135

(57) ABSTRACT

A card connector device includes a case having a receptacle space for receiving a card having a specific width and an opening for inserting the card therethrough; a connector disposed at an end portion of the receptacle space in a direction that the card is inserted for connecting the card; a shutter member arranged adjacent to the opening to be pushed with a front end of the card when the card is inserted, so that the shutter member rotates from a closed position to an open position around an axial line extending along a width direction of the card; and a stopper member for preventing the shutter member from rotating toward the open position when a card with a width smaller than the specific width is inserted.

### BACKGROUND OF THE INVENTION

The present invention relates to a card connector device, especially a card connector device having a shutter member capable of opening and closing disposed at an opening of the card connector device for inserting a card.

In a connector device with a shutter member, when a card is inserted into the connector device through an opening having a specific width, it is physically impossible to insert a card having a width greater than the specific width. On the other hand, a card having a width smaller than the specific width may be mistakenly inserted into the connector device.

Patent Reference 1 has disclosed a mechanism for preventing a card with a small width from being mistakenly inserted into a connector device. In Patent Reference 1, a door main body is attached as a shutter member to an opening of a case for inserting a card, so that the door main body is rotatable around an axial line extending in a width direction of the opening, i.e., a width direction of the card.

The door main body is provided with two window portions, and a door lock member is rotatably attached to the door main body to be situated at the respective window portions. The door lock member includes pressed arm portions extending forward and lock arm portions extending rearward relative to the door main body. A torsion spring is provided for pressing distal ends of the arm portions against fixed arm portions disposed in the case. The pressed arm portions are located closer to a front side in a card insertion direction than other portions. The pressed arm portions are disposed in the respective window portions at positions corresponding to both edges of a card with a standard width in a width direction.

In Patent Reference 1, the card with a standard width pushes the pressed arm portions of the door lock member with front edge surfaces of the both edges thereof. Accordingly, the lock arm portions are released from the fixed projections, so that the door main body rotates in an opening direction for inserting the card. When a card has a width smaller than the standard width, the card does not push both of the pressed arm portions. Accordingly, one of the lock arm portions remains engaging one of the fixed projections, and the door main body does not open. Patent Reference 1: Japanese Patent Publication No. 2001-67441

In the structure disclosed in Patent reference 1, it is necessary to provide the fixed projections in the case. Accordingly, when a card is inserted into the case, a front end of the card may hit the fixed projections. In order to securely prevent the front end of the card from hitting the fixed projections, it is necessary to provide the fixed projections at specific positions, thereby constraining a design of the device, making a surrounding structure complex, and increasing the number of parts.

The door main body, i.e., the shutter member, has a thickness substantially same as that of the card. Accordingly, it is difficult to design and assemble the door lock member and other parts in a small space. Further, the door main body has the two window portions having a large size as opposed to the small space, thereby reducing strength of the door main body.

In view of the problems described above, an object of the present invention is to provide a card electrical connector device with a simple structure. In the invention, it is possible to prevent a card from mistakenly being inserted without reducing strength of a shutter member.

Further objects and advantages of the invention will be apparent from the following description of the invention.

### SUMMARY OF THE INVENTION

In order to attain the objects described above, according to the present invention, a card connector device includes a case having a receptacle space for receiving a card having a specific width and an opening for inserting the card therethrough; a connector disposed at an end portion of the receptacle space in a direction that the card is inserted for connecting the card; a shutter member arranged adjacent to the opening to be pushed with a front end of the card when the card is inserted, so that the shutter member rotates from a closed position to an open position around an axial line extending along a width direction of the card; and a stopper member for preventing the shutter member from rotating toward the open position when a card with a width smaller than the specific width is inserted.

According to the present invention, the stopper member is disposed separately from the shutter member to be freely rotatable between the closed position and the open position. The stopper member is provided with abutting portions formed at positions corresponding to both edge portions of the card in the width direction and an engaging portion formed on a backside surface of the shutter member. An urging device is provided for urging the stopper member toward the closed position when the stopper member rotates from the open position to closed portion. When the card with the specific width is inserted into the receptacle space, front end surfaces of the edge portions of the card push the abutting portions, so that the engaging portion moves to a position against an urging force of the urging device for allowing the shutter member to rotate toward the open position.

With the configuration described above, when the card with the specific width is inserted through the opening, the front end surfaces of the card push both of the abutting portions of the stopper member disposed at the two positions in the width direction of the card. Accordingly, the stopper member rotates against an urging force of the urging device, so that the abutting portions move to the positions away from the backside surface of the shutter member. As a result, the shutter member is not restrained at the closed position, and is pushed with the card to rotate to the open position.

On the other hand, when the card with a width smaller than the specific width is inserted through the opening, the card does not push both of the abutting portions but just one of the abutting portions. Accordingly, the other of the abutting portions remains at the backside surface of the shutter member, thereby not allowing the shutter member to rotate to the open position. As a result, it is possible to insert the card with the specific width, and to prevent the card with a width smaller than the specific width from being inserted.

According to the present invention, the stopper member may include an intermediate portion extending in a front-to-rear direction in a space near both ends of the shutter member in the width direction situated at the closed position. The abutting portions extend outwardly from a front portion of the intermediate portion in the width direction. The engaging portion extends inwardly from a rear portion of the intermediate portion in the width direction, and is disposed at a position where the engaging portion can abut against a backside surface of the shutter member. A member having the opening for inserting the card supports the stopper member to rotate the axial line. In the stopper member, the intermediate portion is disposed to pass through in the front-to-rear direction a gap between the both ends of the shutter member in the width direction and the member for supporting the shutter member. Accordingly, it is not necessary to provide a large cut portion in the shutter member.

The stopper member may be formed of, for example, a metal plate having a crank shape bending relative to a plate surface. The abutting portions have surfaces contacting with the front end surface of the card. The engaging portion has a surface contacting with the backside surface of the shutter member. In this case, the shutter member is disposed away from the member for supporting the shutter member by a distance larger than a thickness of the metal plate constituting the intermediate portion.

According to a shape of the stopper member, the shutter member may have cut portions at the both ends thereof in the width direction. The intermediate portion of the stopper member extends in the cut portions in the front-to-rear direction.

According to the present invention, the shutter member may include a projecting portion or a step portion adjacent to the engaging portion of the stopper member at a rear surface of the shutter member situated at the closed position. When the front end surface of the card pushes the shutter member without pushing the abutting portion of the stopper member, the projecting portion or the step portion abuts against the engaging portion of the stopper member to fix a position of the engaging portion when the shutter member starts rotating toward the open position. Accordingly, when the card is inserted, the shutter member engages the stopper member with the projecting portion or the step portion to lock and integrate with the stopper portion at the closed position. As a result, even when a large force is applied to the shutter member, it is possible to securely hold the shutter member at the closed position, and to reinforce the structure.

Further, the projecting portion may include a groove portion capable of retaining a part of the engaging portion of the stopper member. Accordingly, when the shutter member is pushed and the stopper member is not pushed, the groove portion abuts against the engaging portion for fixing a position of the engaging portion.

According to the present invention, the shutter member may include a recess portion in the backside surface thereof situated at the closed position for further securely maintaining the closed position. Accordingly, when the front end surface of the card pushes the shutter member without pushing the abutting portion of the stopper member, an inner surface of the recess portion is pressed against the engaging portion of the stopper member to fix a position of the engaging portion when the shutter member starts rotating toward the open position.

According to the present invention, the rotational axial line of the stopper member may be aligned in a direction perpendicular to a surface of the card, or in parallel to the rotational axial line of the shutter member.

As described above, in the present invention, the shutter member and the stopper member are disposed separately. Accordingly, with the engaging portion integrated with the abutting portion of the stopper member, it is possible to easily and securely prevent the shutter member from moving toward the open position and release the shutter member.

### BRIEF DESCRIPTION OF THE DRAWINGS

FIG. 1 is an exploded perspective view showing a card connector device according to a first embodiment of the present invention in a state before a card is inserted;

FIG. 2 is a plan view showing the card connector device shown in FIG. 1 in an assembled state before a card is inserted;

FIG. 3 is a side view of the card connector device shown in FIG. 2;

FIG. 4 is a front view of the card connector device shown in FIG. 2;

FIG. 5 is a plan view showing the card connector device shown in FIG. 1 when a card with a standard width is inserted;

FIG. 6 is a side view showing the card connector device shown in FIG. 1 when the card with the standard width is inserted;

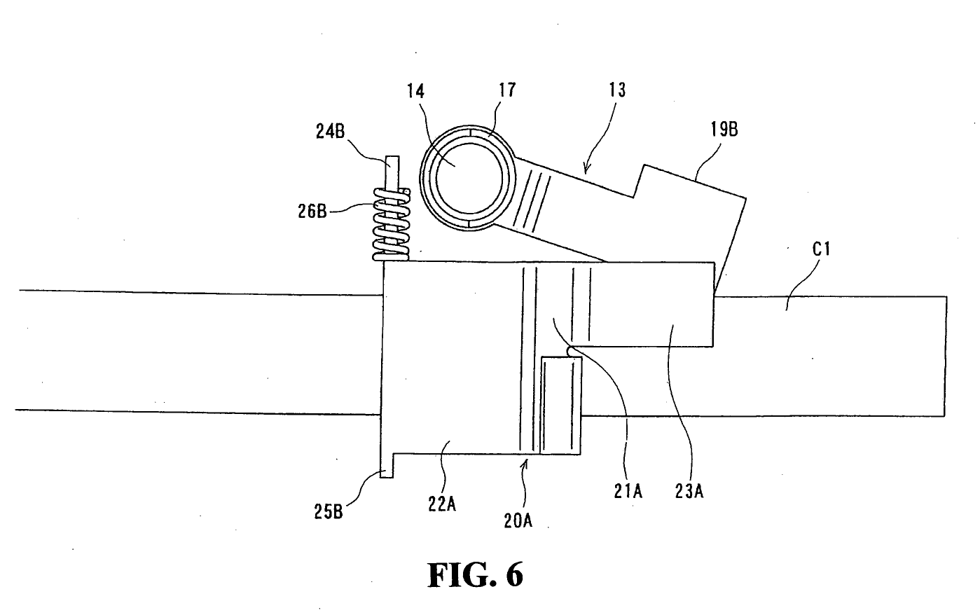

FIG. 7 is a plan view showing the card connector device shown in FIG. 1 relative to a card with a width smaller than the standard width;

FIG. 8 is a side sectional view showing a modified example of the card connector device shown in FIG. 1 relative to a card with a width smaller than the standard width;

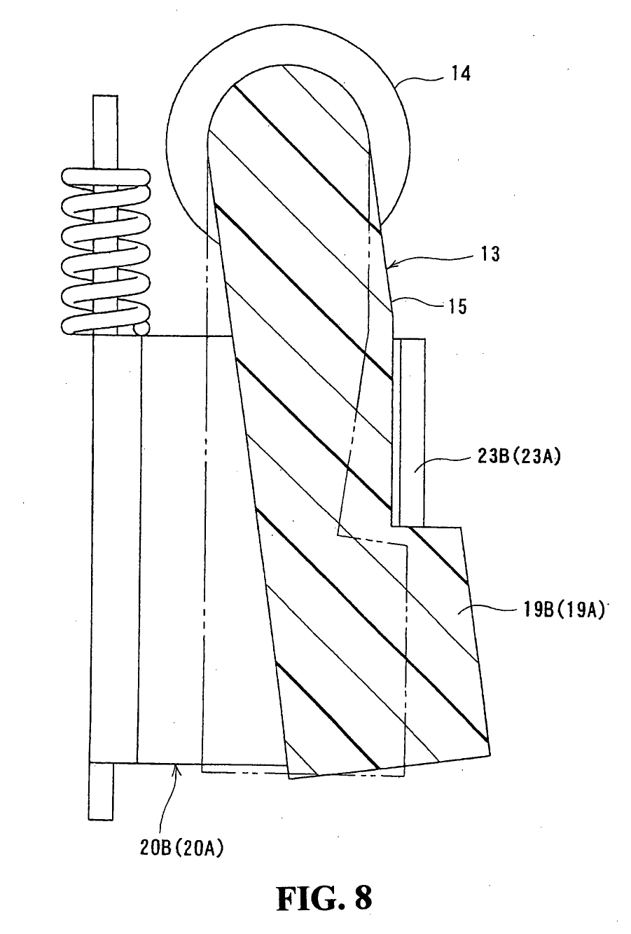

FIG. 9 is a perspective view showing another modified example of the card connector device according to the first embodiment of the present invention;

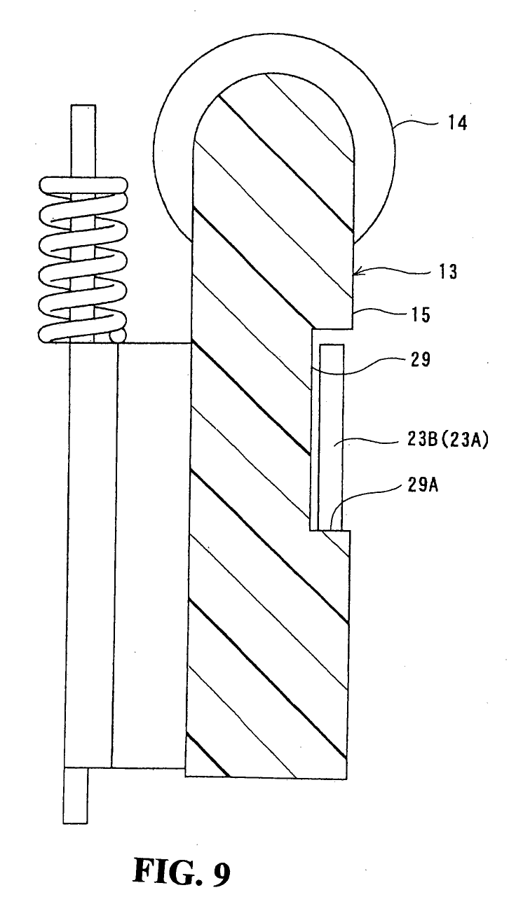

FIG. 10 is a perspective view showing a card connector device according to a second embodiment of the present invention in a state that a shutter member is closed;

FIG. 11 is a perspective view showing the card connector device shown in FIG. 10 in a state that the shutter member opens;

FIG. 12 is a perspective view showing the card connector device shown in FIG. 10 in a state that the shutter member and a stopper member are locked; and

FIG. 13 is a perspective view showing a card connector device according to a third embodiment of the present invention in a state that a shutter member is closed.

### DETAILED DESCRIPTION OF THE PREFERRED EMBODIMENTS

Hereunder, embodiments of the present invention will be explained with reference to the accompanying drawings.

### First Embodiment

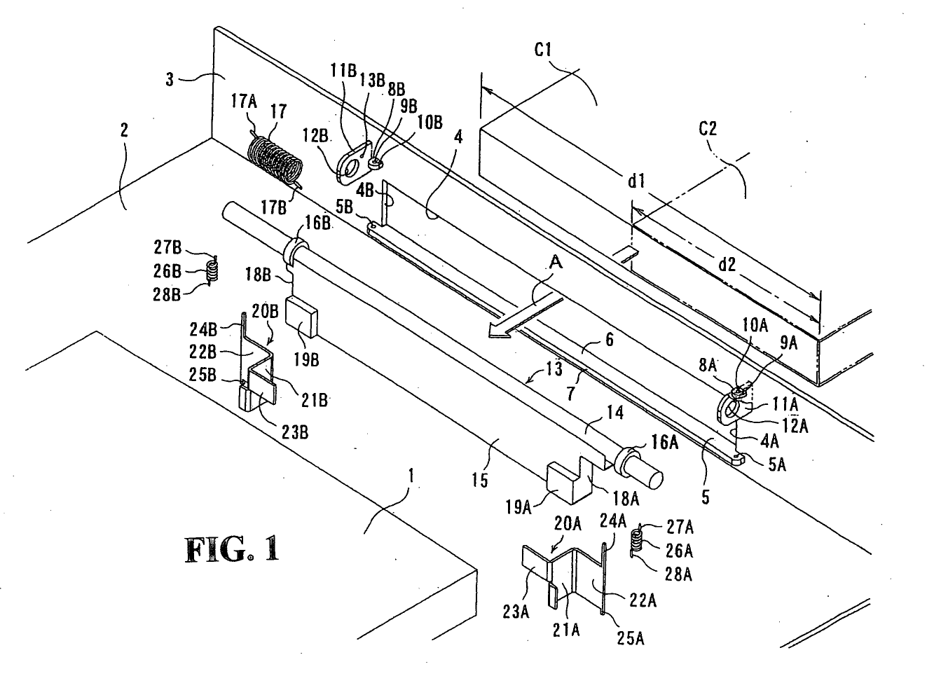

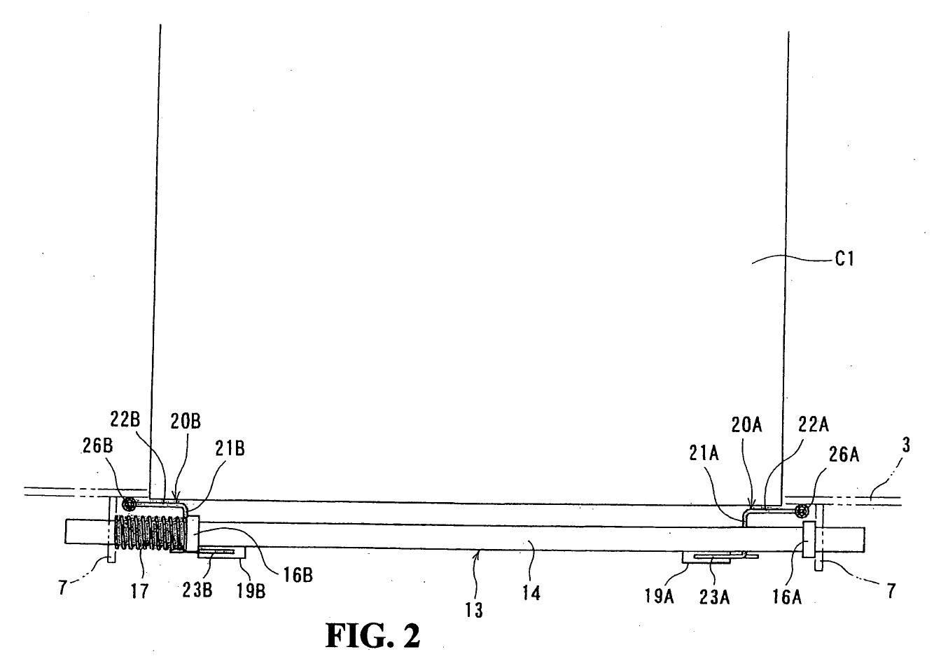

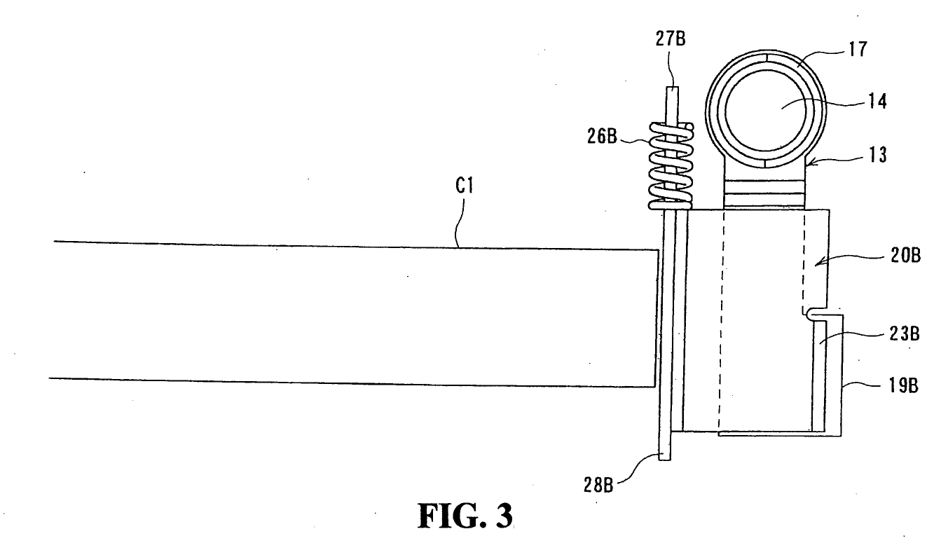

FIG. 1 is an exploded perspective view showing a card connector device according to a first embodiment of the present invention. The card connector device is viewed from a side of a case into which a card is inserted in a direction of viewing the card before being inserted. FIG. 2 is a plan view showing the card connector device shown in FIG. 1 in an assembled state before the card is inserted. FIG. 3 is a side view of a shutter member and a stopper member of the card connector device shown in FIG. 2.

In FIGS. 1 to 3, a card C1 having a standard width d1 is inserted into a case 1 in an arrow direction A. A connector (not shown) is disposed at an end portion of the case in a direction that the card is inserted for connecting the card. The case is attached to a housing 2 of an electrical device. The housing 2 has a front panel 3, and an opening 4 with a window shape is formed in the front panel 3. The opening 4 has a size such that the card C1 with the standard width d1 can be inserted in the arrow direction A.

A guide flange 5 is disposed at a lower edge of the opening 4 along a width direction of the opening 4 to project from a backside surface of the front panel 3. When the card C1 is inserted, an upper surface 6 of the guide flange 5 guides a lower surface of the card C1, and a rear edge 7 (described alter) of the guide flange 5 abuts against the shutter member. The guide flange 5 extends outwardly in the width direction further than the opening 4, and has small holes 5A and 5B passing through in a vertical direction at both end portions thereof, respectively. Lateral small projecting pieces 8A and 8B corresponding to the small holes 5A and 5B are disposed on the backside surface of the front panel 3 at positions slightly above the small holes 5A and 5B at an upper edge of the opening 4, and are provided with small holes 9A and 9B passing through in a vertical direction at both end portions thereof, respectively. The small holes 5A and 5B have axial lines along in the vertical direction common with those of the small holes 9A and 9B. The lateral small projecting pieces 8A and 8B are also provided with small engaging holes 10A and 10B, respectively, in addition to the small holes 9A and 9B.

Vertical projecting pieces 11A and 11B are disposed adjacent to the lateral projecting pieces 8A and 8B disposed at both ends of the opening 4 in the width direction, and are provided with shaft supporting holes 12A and 12B, respectively. One of the vertical projecting pieces 11A and 11B disposed on the left side in FIG. 1 also includes a small engaging hole 13B.

A shutter member 13 is rotatably supported in the shaft supporting holes 12A and 12B formed in the vertical projecting pieces 11A and 11B. The shutter member 131 integrally includes a shaft portion 14 extending in a lateral direction and a shutter portion 15 with a plate shape extending downwardly from the shaft portion 14. A length of the shaft portion 14 is larger than a distance between the vertical projecting pieces 11A and 11B. Flange portions 16A and 16B are disposed on both ends of the shaft portion 14. The shaft portion 14 is supported in the shaft supporting holes 12A and 12B of the vertical projecting pieces 11A and 11B at portions thereof outside of the flange portions 16A and 16B in an axial direction to be rotatable around the shaft.

The flange portion 16A abuts against the corresponding vertical projecting piece 11A. A compressed torsion spring 17 is disposed on the shaft portion 14 between the flange portion 16B and the corresponding vertical projecting piece 11B. The spring 17 has one end 17A engaging the engaging hole 13B of the vertical projecting piece 11B and the other end 17B engaging the shutter portion 15 near the flange portion 16B. Accordingly, the spring 17 urges the shutter member 13 toward the rear edge 7 of the guide flange 5 of the front panel 3 around the shaft portion 14, so that the right flange portion 16A abuts against the vertical projecting piece 11A (FIG. 2).

The shutter portion 15 with a plate shape integrated with the shaft portion 14 has a width covering a whole range between the flange portions 16A and 16B, and includes cut portions 18A and 18B at both ends thereof. In the embodiment, the cut portion 18A on the right side has a size in the width direction larger than that of the cut portion 18B on the left side. Spaces are formed between the cut portions 18A and 18B and side edges 4A and 4B of the opening 4 in the width direction. Projections 19A and 19B are formed on a backside surface of the shutter portion 15 at positions corresponding to the cut portions 18A and 18B.

Stopper members 20A and 20B are rotatably supported in the small holes 5A and 9A and 5B and 9B disposed in the vertical direction at the both ends of the opening 4 in the width direction. The stopper members 20A and 20B have a symmetrical shape relative to the width direction, and are formed of a metal plate bent in a crank shape in a plate thickness direction.

The stopper members 20A and 20B are bent by the right angle at front and rear sides of intermediate portions 21A and 21B relative to the intermediate portions 21A and 21B. Abutting portions 22A and 22B extending outwardly in the width direction are disposed on the front sides of the stopper members 20A and 20B. Engaging portions 23A and 23B extending inwardly in the width direction are disposed on the rear sides of the stopper members 20A and 20B. The stopper members 20A and 20B include shaft portions 24A, 25A, 24B, and 25B with a pin shape extending from edges of the abutting portions 22A and 22B in the vertical direction. The shaft portions 24A and 25A are rotatably fitted in the small holes 9A and 5A at the backside surface of the front panel 3. The shaft portions 24B and 25B are rotatably fitted in the small holes 9B and 5B at the backside surface of the front panel 3. Torsion springs 26A and 26B are fitted on the shaft portions 24A and 24B. The torsion springs 26A and 26B have upper end portions 27A and 27B engaging the small holes 10A and 10B and lower end portions 28A and 28B engaging the abutting portions 22A and 22B.

When the shaft portions 24A, 25A, 24B, and 25B are supported in the small holes 5A, 5B, 9A, and 9B, the stopper members 20A and 20B are situated to pass through the spaces between the cut portions 18A and 18B and the side edges 4A and 4B of the opening 4. Accordingly, as shown in FIG. 2, the abutting portions 22A and 22B of the stopper members 20A and 20B are situated on a front side of the shutter member 13, and the engaging portions 23A and 23B are situated on a rear side of the shutter member 13. The torsion springs 26A and 26B fitted in the shaft portions 24A and 24B urge the abutting portions 22A and 22B of the stopper members 20A and 20B toward the backside surface of the shutter portion 15.

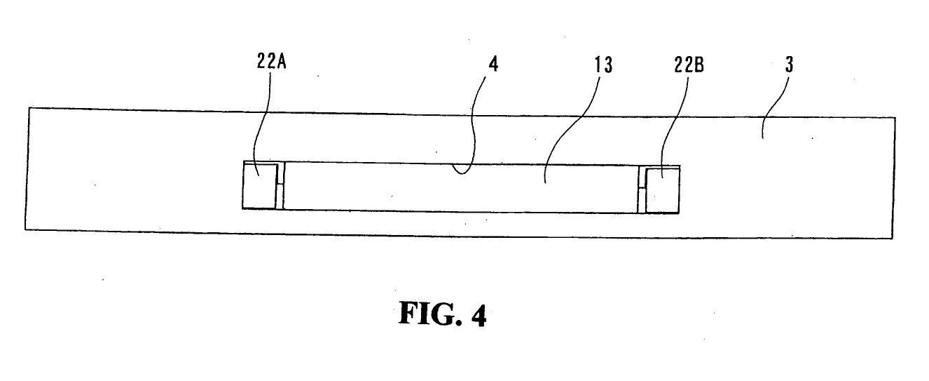

Accordingly, the shutter member 13 is urged with the torsion springs 26A and 26B on the backside thereof through the stopper members 20A and 20B to abut against the rear edge 7 of the guide flange 5. As a result, the opening 4 of the front panel 3 remains in a closed state. When the shutter member 13 is closed, the abutting portions 22A and 22B of the stopper members 20A and 20B are situated at the both ends in the width direction in the opening 4 of the front panel 3 as shown in FIG. 4 viewed in the insertion direction of the card C1, that is, the arrow direction A in FIG. 1.

An operation of inserting the card according to the present embodiment will be explained next.

(1) Insertion of a Card with the Standard Width

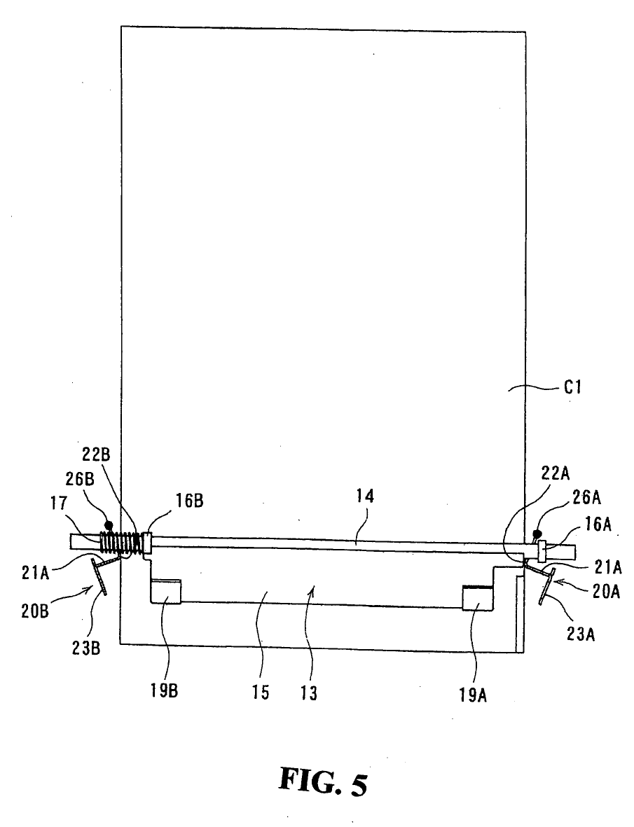

As described above, the abutting portions 22A and 22B of the stopper members 20A and 20B are situated at the both ends in the width direction in the opening 4 of the front panel 3 having the width corresponding to the standard width d1 of the card C1 shown in FIG. 4. When the card C1 with the standard width d1 is inserted as shown in FIG. 1, the front end surface of the card C1 pushes both of the abutting portions 22A and 22B. Accordingly, the stopper members 20A and 20B rotate around the shaft portions 24A, 25A, 24B, and 25B in the opening direction against the urging force of the torsion springs 26A and 26B, so that the engaging portions 23A and 23B are shifted outwardly from the range of the backside surface of the shutter member 13 to engagement releasing positions (FIG. 5). As a result, the shutter member 13 is pushed with the front end surface of the card C1 to rotate upwardly in the opening direction against the force of the spring 17. Therefore, the card C1 passes through the opening 4, and is inserted into the case 1 at a specific position to be connected to the connector.

(2) Insertion of a Card with a Width Smaller than the Standard Width

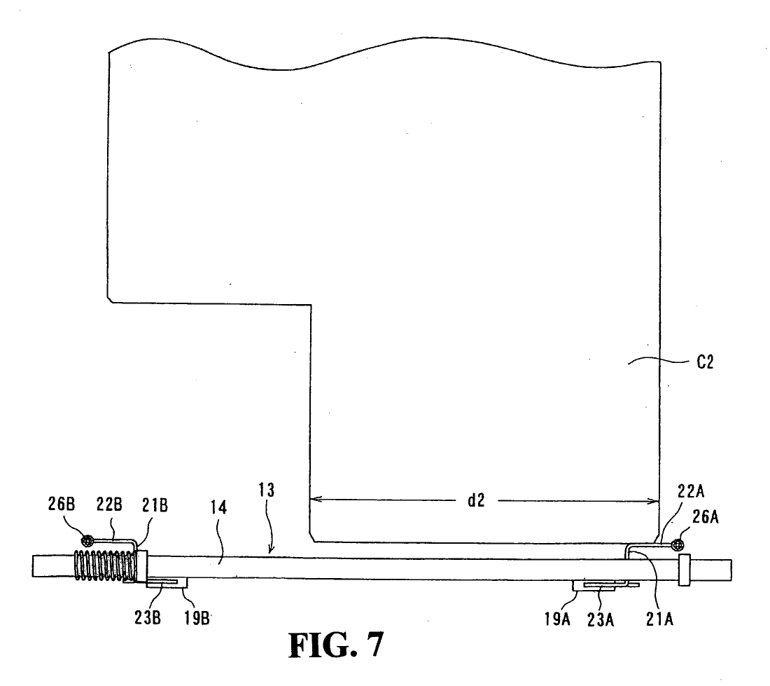

As shown in FIGS. 1 and 7, when a card C2 with a width d2 smaller than the standard width d1 is inserted, a front end surface of the card C2 does not abut against the abutting portions 22A and 22B, or abuts against at lease one of the abutting portions 22A and 22B, for example, the abutting portion 22A on the right side as shown in FIG. 7. Accordingly, at least the other of the abutting portions 22A and 22B is not pushed with the card.

When the other of the abutting portions 22A and 22B, for example, the abutting portion 22B, is not pushed with the card, the engaging portion 23B of the stopper member 20B remains at the engaging position to prevent the shutter member 13 from rotating in the opening direction. Further, in the present embodiment, the projections 19A and 19B are provided on the backside surface of the shutter member 13. When the shutter member 13 is closed, the engaging portions 23A and 23B of the stopper members 20A and 20B are situated right above the projections 19A and 19B.

Accordingly, when the card C2 with the width d2 smaller than the standard width d1 is inserted, if the shutter member 13 slightly rotates in the circumferential direction, stepwise upper surfaces of the projections 19A and 19B engage the lower edges of the engaging portions 23A and 23B to apply an upward force, thereby becoming a locked state. Accordingly, the shutter member 13 does not rotate further, thereby securely preventing the shutter member 13 from rotating in the opening direction. When the card C2 pushes the abutting portions 22A, the stopper member 20A rotates slightly in the opening direction. However, right after the rotation, the stopper member 20B engages and is locked, so that the stopper member 20A also remains at the engaging position as well as the stopper member 20B.

As described above, in the present embodiment, it is possible to securely prevent a card with a width smaller than the standard width from being inserted. When a card with a width larger than the standard width is inserted, the card can push the abutting portions. However, the width of the opening is smaller than the width of the card, so that the card cannot be inserted.

### Second Embodiment

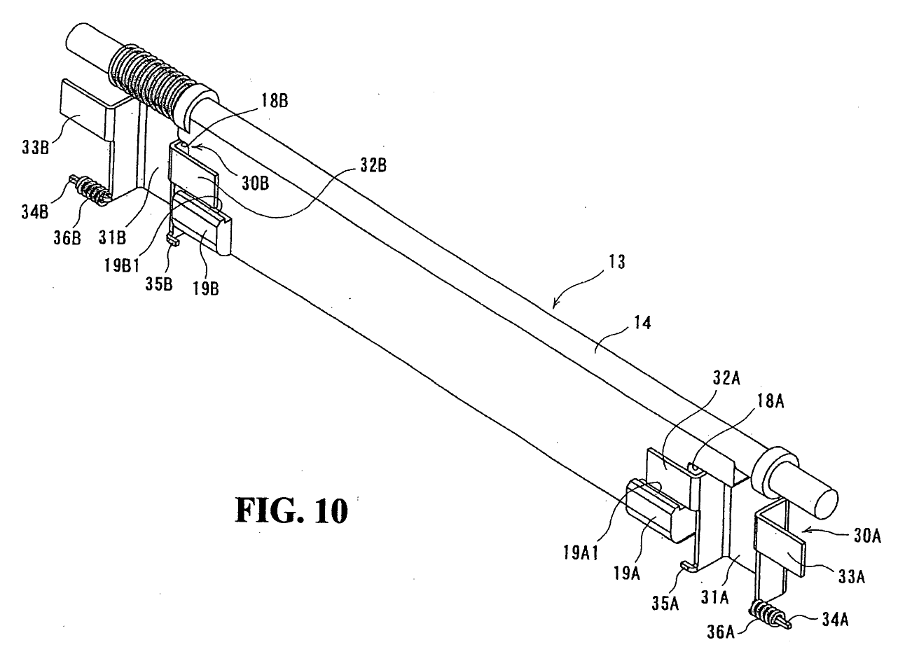

In the first embodiment, the rotational axial line of the shutter member is aligned in a direction perpendicular to the rotational shafts of the stopper members. In the second embodiment, as shown in FIG. 10, the rotational axial line of the shutter member and the rotational shafts of the stopper members are aligned in parallel, and are situated at positions opposite to the opening.

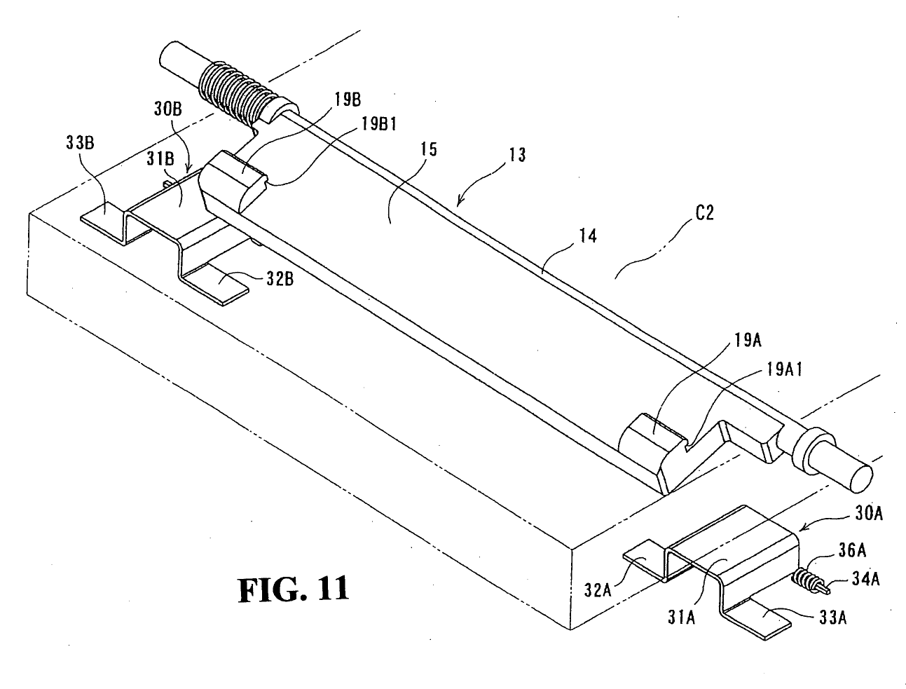

FIG. 10 is a perspective view showing a card connector device according to the second embodiment of the present invention in a state that the shutter member 13 is closed. FIG. 11 is a perspective view showing the card connector device shown in FIG. 10 in a state that the shutter member 13 opens. A member for supporting the shutter member 13 and stopper members 30A and 30B to be freely rotatable is omitted.

The shutter member 13 has a structure substantially same as that in the first embodiment. It is preferred that the projections 19A and 19B have groove portions 19A1 and 19B1 in the upper surfaces thereof, respectively. Lower edges of the engaging portions 23A and 23B of the stopper members 20A and 20B enter the groove portions 19A1 and 19B1.

The shutter members 30A and 30B are formed in groove shaped portions 31A and 31B with a U shape. The shutter members 30A and 30B also have portions with a wing shape extending from opening edges of the groove shaped portions 30A and 30B toward both sides. Engaging portions 32A and 32B are formed as portions extending inwardly. Supporting portions 33A and 33B are formed as portions extending outwardly for stabilizing a posture upon rotating in the opening direction. The groove shaped portions 31A and 31B have outer surfaces (backside surfaces in FIG. 10) protruding to the front side of the shutter member 13 through the cut portions 18A and 18B to form abutting portions.

Shaft portions 34A, 35A, 34B, and 35B are disposed on lower opening edges of the groove shaped portions 31A and 31B, and extend in a direction in parallel to the axial line of the shaft portion 14 of the shutter member 13. The shaft portions 34A, 35A, 34B, and 35B are supported to freely rotate. Torsion springs 36A and 36B are fitted on the shaft portions 34A and 34B for urging the stopper members 30A and 30B in the closing direction. As shown in FIG. 10, the engaging portions 32A and 32B of the stopper members 30A and 30B are urged toward the backside surface of the shutter member 13 at the closed position with the springs 36A and 36B. The lower edges of the engaging portions 32A and 32B correspond to the groove portions 19A1 and 19B1 in the upper surfaces of the projections 19A and 19B.

In the present embodiment, when the card C1 with the standard width is inserted, the front end surface of the card C1 pushes the abutting portions (outer surfaces of the groove shaped portions 31A and 31B) of the stopper members 30A and 30B. Accordingly, the stopper members 30A and 30B rotate around the shaft portions 34A and 34B in the opening direction against the urging force of the springs 36A and 36B (FIG. 11). At the open position, the engaging portions 32A and 32B and the supporting portions 33a and 33B of the stopper members 30A and 30B contact with a horizontal surface of a housing, thereby stabilizing a posture. The card C1 slides on a horizontal surface of the abutting portions to rotate the shutter member 13 upwardly, and passes through the opening into the case.

In the present embodiment, similar to the first embodiment, when the card C2 with the width d2 smaller than the standard width d1 is inserted, the front end surface of the card C2 does not push at lease one of the abutting portions of the stopper members 30A and 30B. For example, when the card C2 does not push the abutting portion of the stopper member 30A, the engaging portion 32B remains in the engaging state with the backside surface of the shutter member 13.

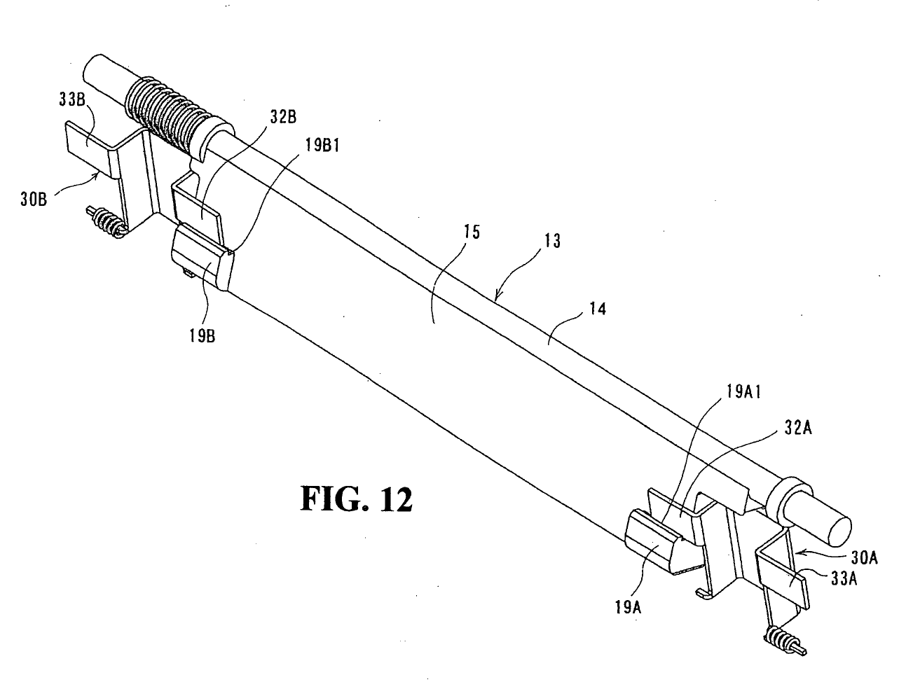

When the card pushes the shutter member to rotate slightly, the stopper member 30B rotates. In this case, since the rotational shafts are situated at opposing positions, interference viewed from the shaft direction increases. Accordingly, the engaging portion 32B engages a front sidewall of the groove portion 19B1, or the lower edge of the engaging portion 32B engages an upper edge of the groove portion 19B1 of the projection 19B of the shutter member 13. As a result, the lower edge of the engaging portion 32B and the groove portion 19B1 become a locked state as shown in FIG. 12, thereby securely preventing the shutter member 13 from rotating in the opening direction.

In the present embodiment, the projections 19A and 19B are provided with the groove portions. Alternatively, without the groove portions, it is sufficient for the stopper members that the projections 19A and 19B are situated at positions for restricting the rotational directions of the engaging portions 32A and 32B. Similarly, the engaging portions 32A and 32B are not necessarily retained in the groove portions at the closed position.

### Third Embodiment

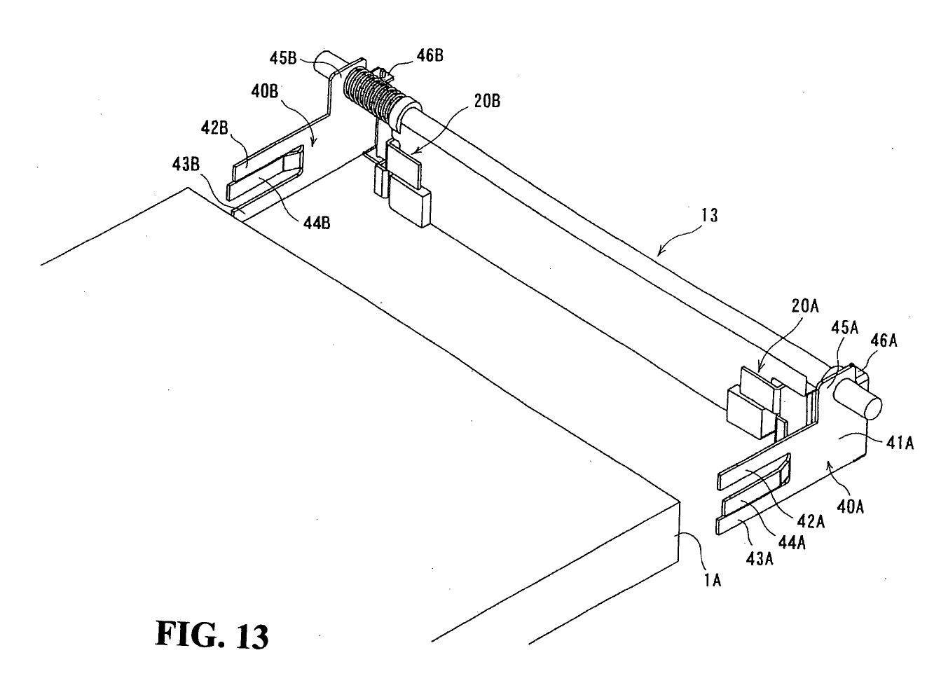

In the first and second embodiments, the shutter member and the stopper members are rotatably supported on the front panel. In the third embodiment, as shown in FIG. 13, the shutter member and the stopper members are supported on supporting members 40A and 40B directly disposed on the case. The shutter member 13 and the stopper members 20A and 20B are substantially same as those in the first embodiment.

The supporting members 40A and 40B are formed of a metal plate through a cutting and bending process. The supporting members 40A and 40B have a symmetrical shape relative to the width direction of the opening 4 to be attached to an opening side edge 1A of the case 1. First leg portions 42A, 43A, 42B, and 43B extend forward from upper and lower edges of base portions 41A and 41B with a plate shape. Second leg portions 44A and 44B are shifted from the first leg portions by a plate thickness of the case 1, and extend in the same direction as the first leg portions. The opening side edge of the case is sandwiched between the first leg portions 42A, 43A, 42B, and 43B, and the second leg portions 44A and 44B, so that the supporting members 40A and 40B are attached to the case 1.

The supporting members 40A and 40B include shaft supporting portions 45A and 45B at right upper portions thereof for supporting both ends of the shaft portion 14 of the shutter member 13 to freely rotate. Horizontal flange portions 46A and 46B are disposed right ends of the supporting members 40A and 40B at upper and lower positions for supporting the shaft portions 24A, 25A, 24B, and 25B of the stopper members 20A and 20B to freely rotate.

In the present embodiment, the shutter member 13 and the stopper members 20A and 20B in addition to related parts are assembled in the supporting members 40A and 40B to form a set of the components. Then, the set can be attached to the case 1, thereby simplifying the assembly process.

In the present invention, the following modifications are applicable to the first to third embodiments. The abutting portions 22A, 22B, 31A, and 31B of the stopper members 20A, 20B, 30A, and 30B protrude toward the front surface side. Alternatively, they may be situated at the rear surface side as far as they are situated at positions for preventing a card with a width smaller than the standard width from being inserted.

Further, the various springs not necessarily always urge the shutter member toward the closed position. The spring may become a natural state at the closed position, and generate the urging force when the shutter member rotates toward the open position. The shutter member may be formed of metal. When the shutter member is formed of a plate member, a spring piece may be integrally formed as the urging member.

The disclosure of Japanese Patent Application No. 2004-249626, filed on Aug. 30, 2004, is incorporated in the application.

While the invention has been explained with reference to the specific embodiments of the invention, the explanation is illustrative and the invention is limited only by the appended claims.

What is claimed is:

1. A card connection device for receiving and connecting a first card having a first width, comprising:
a case having an opening and a receptacle space, said opening having an opening width equal to or slightly larger than the first width;
a shutter member disposed adjacent to the opening to be freely rotatable between an open position and a closed position around an axis line extending in a width direction of the first card;
a stopper member for preventing the shutter member from rotating toward the open position when a second card having a second width smaller than the first width is inserted, said stopper member being disposed separately from the shutter member to be freely rotatable between the closed position and the open position, said stopper member including abutting portions formed at positions corresponding to both edge portions of the first card in the width direction and an engaging portion formed on a backside surface of the shutter member; and
an urging device for urging the shutter member toward the closed position when the stopper member rotates from the open position to the closed portion so that when the first card is inserted into the receptacle space, a front end surface of the first card pushes the abutting portions and the engaging portion moves to a position against an urging force of the urging device for allowing the shutter member to rotate toward the open position.

2. The card connection device according to claim 1, wherein said stopper member include an intermediate portion extending in a front-to-rear direction in a space near both ends of the shutter member in the width direction situated at the closed position, said abutting portions extending outwardly from a front portion of the intermediate portion in the width direction, said engaging portion extending inwardly from a rear portion of the intermediate portion in the width direction and being disposed at a position where the engaging portion can abut against a backside surface of the shutter member, said stopper member being supported on a member having the opening for inserting the card to rotate around a rotational axial line.

3. The card connection device according to claim 1, wherein said stopper member is formed of a metal plate having a crank shape bending relative to a plate surface thereof, said abutting portion having a first portion on the plate surface contacting with the front end surface of the first card, said engaging portion having a second portion on the plate surface contacting with the backside surface of the shutter member.

4. The card connection device according to claim 1, wherein said shutter member includes cut portions at both ends thereof in the width direction, said intermediate portion extending in the front-to-rear direction in the cut portions.

5. The card connection device according to claim 1, wherein said shutter member includes a projecting portion or a step portion adjacent to the engaging portion at a backside surface of the shutter member situated at the closed position so that when the front end surface of the first card pushes the shutter member without pushing the abutting portions, the projecting portion or the step portion abuts against the engaging portion to fix a position of the engaging portion when the shutter member starts rotating toward the open position.

6. The card connection device according to claim 5, wherein said projecting portion includes a groove portion for retaining the engaging portions so that when the shutter member is pushed and the stopper member is not pushed, the groove portion abuts against the engaging portion for fixing a position of the engaging portion.

7. The card connection device according to claim 1, wherein said shutter member includes a recess portion in a backside surface thereof situated at the closed position so that when the front end surface of the first card pushes the shutter member without pushing the abutting portions of the stopper member, an inner surface of the recess portion is pressed against the engaging portion of the stopper member to fix a position of the engaging portion when the shutter member starts rotating toward the open position.

8. The card connection device according to claim 1, wherein said the stopper member has a rotational axial line aligned in a direction perpendicular to a surface of the first card, or in parallel to a rotational axial line of the shutter member.
